(19) United States
(12) Patent Application Publication
(10) Pub. No.: US 2020/0091805 A1
(43) Pub. Date: Mar. 19, 2020

(54) DYNAMO-ELECTRIC MACHINE WITH REDUCED COGGING TORQUE

(71) Applicant: SCHAEFFLER TECHNOLOGIES AG & CO. KG, HERZOGENAURACH (DE)

(72) Inventors: Jörg KEGELER, Schleusingen (DE); André SPÖRER, Suhl (DE)

(73) Assignee: SCHAEFFLER TECHNOLOGIES AG & CO. KG, HERZOGENAURACH (DE)

(21) Appl. No.: 16/495,118

(22) PCT Filed: Dec. 20, 2017
(86) PCT No.: PCT/DE2017/101087

§ 371 Date: Sep. 18, 2019

(30) Foreign Application Priority Data
Mar. 21, 2017 (DE) 10 2017 105 977.6

(51) Int. Cl. H02K 29/03; H02K 3/26; H02K 41/03; H02K 21/24

(52) U.S. Cl. CPC H02K 29/03; H02K 3/26; H02K 2203/03; H02K 21/24; H02K 41/031

(57) ABSTRACT

A dynamo-electric machine includes a primary part having a plurality of teeth, grooves that are located between the teeth and a yoke that is produced from a ferromagnetic material, a secondary part that is spaced apart from the primary part via an air gap and comprises a plurality of permanent magnets that lie adjacent to one another with alternating polarity, a multi-phase tooth coil winding that is arranged in the grooves, wherein adjacent tooth coils are connected to form groups having an identical electrical phase, wherein adjacent teeth of the groups of tooth coils having an identical electrical phase are connected in a magnetically conductive manner via the yoke and the yoke is interrupted between adjacent tooth coils having a different electrical phase.

### CROSS-REFERENCE TO RELATED APPLICATIONS

This application is the U.S. National Phase of PCT/DE2017/101087 filed Dec. 20, 2017, which claims priority to DE 102017105977.6 filed Mar. 21, 2017, the entire disclosures of which are incorporated by reference herein.

### TECHNICAL FIELD

The present disclosure relates to a dynamo-electric machine. The disclosure relates both to rotary dynamo-electric machines and also to linear motors.

### BACKGROUND

Electric machines are frequently configured as so-called synchronous motors or brushless DC machines in which a primary part comprises a grooved electrical metal sheet, and a winding for generating an electrical field is arranged in the grooves of said electrical metal sheet. A secondary part of the electrical machine is equipped with permanent magnets, the magnetic field of which interacts with the magnetic field that is generated by the coils of the primary part and thus may generate a drive torque. The winding of the primary part is frequently configured as a so-called tooth coil winding. In this case, the primary part comprises pronounced teeth that are defined on both sides by the grooves. The teeth are respectively equipped with a concentrated tooth coil winding with the result that the winding surrounds the respective tooth in a concentric manner. The tooth coil winding renders it possible to produce machines having a very high power density, since it is possible to realize high so-called copper filling factors using this winding technology.

As a result of the pronounced tooth structure, the air gap that separates the permanent magnet of the secondary part from the metal sheet plate of the primary part is subjected to great changes. The magnetic resistance between the primary part and secondary part changes considerably by virtue of the change of the air gap when changing from a tooth of the primary part to a groove of the primary part. However, as this magnetic resistance changes, so does the force between the primary part and the secondary part. This effect is utilized in particular in the case of reluctance motors in a purposeful manner so as to generate torques. In contrast, in the case of synchronous motors the described groove latching torques are generally undesired since they lead to a fluctuating torque progression and consequently the acoustic characteristics of the machine may be impaired. Furthermore, groove latching torques generally result in increased losses in the iron, in the windings and in the magnets.

DE 10335792A1 discloses an electric machine in which multiple adjacent tooth coils are connected in series within a primary part of the electric machine and during the operation of said machine current is able to flow through, wherein the direction of the winding and the current flow direction change from groove to groove. In order to reduce the reluctance ripple of the machine, a ratio between the groove pitch Tₙ and the pole pitch Tₚ is proposed that is close to 1.

DE 102012103677A1 discloses an electric machine having a stator and a rotor that moves relative thereto. The stator comprises grooves for receiving electrical windings, wherein teeth of the stator are configured between adjacent grooves. During the operation of the machine, a working wave of the magnetomotive force is different from a basic wave of the magnetic flux. The stator comprises at least one recess that is arranged in the tooth region and extends essentially in a radial direction. The recess in the region of the tooth is made responsible for the fact that undesired harmonic components of the magneto-motive force are significantly reduced.

### SUMMARY

The object of the disclosure is to propose a dynamo-electric machine that has low groove latching torques and a high power density.

This object is achieved by a dynamo-electric machine having the features and advantageous embodiments of the disclosure as disclosed below.

A dynamo-electric machine in accordance with the disclosure comprises
a primary part having a plurality of teeth, grooves that are located between the teeth, and a yoke that is produced from a ferromagnetic material,
a secondary part that is spaced apart from the primary part via an air gap and comprises a plurality of permanent magnets that lie adjacent to one another with alternating polarity,
a multi-phase tooth coil winding that is arranged in the grooves, wherein adjacent tooth coils are connected to form groups having an identical electrical phase,
wherein adjacent teeth of the groups of tooth coils having an identical electrical phase are connected in a magnetically conductive manner via the yoke and
the yoke is interrupted between adjacent tooth coils having a different electrical phase.

Usually a magnetic connection between the magnetic circuits of the different electrical phases of the dynamo-electric machine is created via the yoke of the primary part. In accordance with the prior art, a magnetic neutral point is produced between the phases in this manner. The disclosure is now based on the knowledge that the undesired groove latching torques are considerably reduced if the magnetic interaction between the phases is interrupted. Moreover, the disclosure is based on the knowledge that this interruption of the yoke and the associated interruption of the magnetic interaction is the most effective if the interruption occurs between the respective groups of tooth coils having an identical electrical phase.

In accordance with the disclosure, each significant reduction of the magnetic conductivity value at this site in the yoke is described as an interruption of the yoke between adjacent tooth coils having a different electrical phase. Thus, this interruption may not only be caused by completely removing material from the primary part iron but rather also by considerably thinning the electrical metal sheet at this site. It is also possible to provide between the adjacent tooth coils having a different electrical phase a material that has a higher magnetic resistance in comparison to the material of the yoke.

The core concept of DE 102012103677A1 is in fact also to realize undesired groove latching torques by a purposeful reduction of the magnetic conductivity value in the yoke at specific positions. However, said document proposes such an interruption in the tooth region of the primary part. In contrast, it is proposed in accordance with the disclosure to provide the interruption between the adjacent tooth coils having a different phase, in other words respectively between the groups of tooth coils having an identical electrical phase. In particular, it is possible in contrast to DE 102012103677A1 to combine adjacent tooth coils into groups that are energized identically but wound in an alternating winding direction. In this case, the magnetic conductivity value is advantageously purposefully reduced in the yoke region precisely between these groups.

In comparison to DE 102012103677A1, a considerably improved utilization of the primary part iron is realized by virtue of the interruption proposed in accordance with the disclosure of the yoke between the teeth. Because of the interruption proposed in the cited document of the magnetic circuit in the tooth of the primary part, the magnetic conductivity value is weakened at the sites where it is also possible to make also a considerable contribution to the net torque generation.

The interruption proposed in accordance with the disclosure of the yoke between the teeth does not result in a reduction of the copper filling factor. The tooth coils may be arranged just as close as would be the case in a conventional primary part without an interrupted magnetic interaction.

One advantageous embodiment of the disclosure is shown in that the adjacent tooth coils having an identical electrical phase are connected in series and comprise an opposite winding direction. However, the interruption in accordance with the disclosure of the yoke between two groups of coils having an identical electric phase also renders it possible to connect in parallel adjacent coils having an identical electrical phase without generating disadvantageous compensating currents between the windings. Because of the interruption of the yoke, it is ensured that the coils having an identical electrical phase are always subjected to the identical magnetic flux. It is not possible for a magnetic flux from a coil pair of another electrical phase to make a contribution.

A further advantage embodiment is illustrated in that one group respectively comprises precisely two tooth coils that are connected in series, are wound in opposite directions and the same phase current flows through said tooth coils. These two tooth coils that are connected in series may furthermore be connected to one another in a magnetically conductive manner by a U-shaped soft iron part. This occurs in one advantageous embodiment of the disclosure by virtue of the fact that the yoke comprises multiple yoke parts that respectively magnetically connect to one another two teeth having two tooth coils that are connected in series. The primary part of the electrical machine consequently comprises a plurality of U-shaped electrical metal sheet structures, the limbs of which respectively are equipped with tooth coils. The two tooth coils of the thus U-shaped core of the yoke are wound in opposite directions and connected in series.

By virtue of the interruption proposed in accordance with the disclosure of the yoke, the question is posed as to how the different elements of yoke are connected in a mechanical manner to a common primary part. A mechanical connection of the individual elements of the yoke is to be configured so as to realize the effect in accordance with the disclosure in such a manner that the magnetic conductivity value between the groups of tooth coils having an identical electrical phase is considerably reduced in order to suppress to the greatest extent the magnetic flux between the different groups.

In a particularly advantageous manner, this object may be achieved by a primary part that is configured as a circuit board. In one advantageous embodiment of the disclosure, this circuit board supports the yoke, the teeth that are connected to the yoke, and the tooth coils. In the case of the primary part being configured in the form of a circuit board, the interruptions in accordance with the disclosure of the yoke are filled by the composite material of the circuit board. A possible composite material for the circuit board is by way of example FR-4, an epoxy resin that is reinforced with a glass fiber fabric and is used as standard for circuit boards. The circuit board provides the necessary mechanical stability for the primary part and in contrast to a continuous soft iron plate suppresses the magnetic flux between the adjacent groups having an identical phase.

In this case, the circuit board is advantageously configured as a multi-layer printed circuit board and the tooth coils are configured as solenoid coils that respectively comprise multiple flat coils that lie in a vertical direction one above the other. The flat coils are in this case attached by way of example initially to individual printed circuit boards, wherein the individual printed circuit boards may be stacked one above the other so as to form the multi-layer printed circuit board. A flat coil may be arranged on each individual printed circuit board both on the upper face and also on the lower face respectively. In this manner, two individual printed circuit boards that are stacked one above the other form a stack of a total 4 flat coils, wherein the individual printed circuit boards that are stacked one above the other may be separated from one another by an insulating layer, by way of example a pre-preg layer.

In this case, the flat coils that lie one above the other in a vertical direction are expediently electrically connected in series. This may be implemented using electrical through-connections, also referred to as VIA. These flat coils that are consequently electrically connected in series and lie one another the other in a vertical direction correspondingly respectively form a solenoid coil.

Each individual flat coil of the described flat coils may be wound in a spiral shape in their respective plane. Thus by way of example a first flat coil that is located in the top layer of the multi-layer printed circuit board extends when viewed in the plane in a spiral shape from the inside outward. In contrast, a second flat coil that is arranged below the first flat coil when viewed in the vertical direction of the printed circuit board extends in a spiral shape from the outside inward.

The term ‘extends in a spiral shape’ may be understood in this sense to be any type of winding in which the individual windings of such a flat coil are formed by a single planar conductor track and encircle in one plane. The manner in which the conductor tracks are routed may be illustrated in this case by circles but said conductor tracks may also extend in a rectangular pattern.

In a further particular advantageous design of the described embodiment, two vertically adjacent flat coils respectively of one solenoid coil are arranged laterally offset with respect to one another in such a manner that in a cross section perpendicular to the surface of the multi-layer printed circuit board the conductor track sections of one flat coil are arranged in part overlapping in a vertical direction with two conductor track sections of the other flat coil. This feature considerably improves the thermal conductivity value in particular in the lateral direction within the primary part that is configured as a multi-layer printed circuit board. The heat that is generated in the interior of a flat coil may be transmitted very easily to a winding of a vertically and laterally adjacent flat coil that when viewed in the lateral direction is closer to the edge of the printed circuit board. This is because for reasons relating to the process technology, the insulation spacing between two conductor track sections that are located in part overlapping in the vertical direction may be realized considerably smaller than the insulation spacing between windings that are arranged in the same plane of the circuit board.

It is not arbitrarily possible for reasons relating to the process technology to select the spacing between two windings in one plane between the participating conductor track sections to be small. However, the individual printed circuit boards of the multi-layer printed circuit board may be electrically insulated from one another by a comparatively thin pre-preg layer. This pre-preg layer may be reduced by way of example in the region of only 40 μm in order to ensure a sufficient electrical insulation, whereas for reasons relating to process technology it is not possible to select the conductor track section between the individual windings to be smaller than 200 μm. Accordingly, the heat transfer between conductor track sections of vertically adjacent flat coils, which are located in part overlapping in a vertical direction is considerably better than between two conductor track sections of different windings of the flat coil, said conductor track sections being arranged in the same plane. This arrangement creates a type of shingle structure that considerably improves the lateral heat transfer within the multi-layer printed circuit board.

It is possible in a further advantageous embodiment of the disclosure to provide that the outer conductor track sections of adjacent tooth coils engage with one another in a comb-shaped manner with the result that in said cross section respectively one outer conductor track section of one tooth coil is arranged in a vertical direction in part overlapping with at least one outer conductor track section of the adjacent tooth coil. It is possible in this manner to improve the lateral heat transfer between the laterally adjacent solenoid coils.

A dynamo-electric machine according to one of the previously described embodiments may be configured both as a rotary electrical machine and also in the form of a linear motor. In the case of linear motors, the interruption in accordance with the disclosure of the yoke is particularly advantageous since here the Vernier scale displacement that is effective in the case of rotary electric machines occurs with only limited effect. This is to be explained by the edge effects that are caused by the edge teeth of the linear motor.

The disclosure is further described below with reference to exemplary embodiments illustrated in the figures.

### BRIEF DESCRIPTION OF THE DRAWINGS

In the drawings:

FIG. 1 illustrates one embodiment of a dynamo-electric machine in which the interruption in accordance with the disclosure of the yoke between two adjacent coils having a different electrical phase is realized.

FIG. 2 illustrates one embodiment of the disclosure as a circuit board motor.

FIG. 3 illustrates a further embodiment of the disclosure as a circuit board motor with improved heat dissipation.

### DETAILED DESCRIPTION

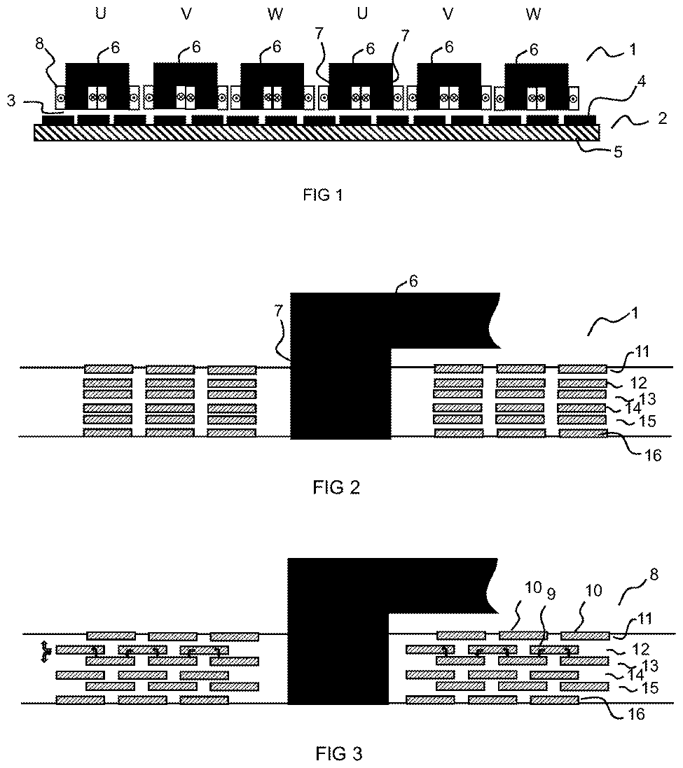

FIG. 1 illustrates a first embodiment of a dynamo-electric machine in the form of a linear motor. The linear motor comprises a primary part 1 and a secondary part 2 that is spaced apart from the primary part 1 via an air gap 3. The secondary part 2 comprises a plurality of permanent magnets 4 that are arranged with alternating polarity on a soft iron plate 5.

The primary part 1 comprises a yoke having multiple yoke parts 6 that are each provided with two limbs 7 that together with the yoke parts 6 form a U-shaped in particular one piece soft iron part. The U-shaped iron core that is produced in this manner is configured so as to reduce eddy currents from electric metal sheets that are insulated from one another. The limbs 7 that are connected to each yoke part 6 form teeth of the primary part that are each equipped with tooth coils 8.

The primary part 1 is configured to be three phase. Each U-shaped iron core supports two tooth coils 8 that are allocated to the same electrical phase. These two tooth coils 8 that are mounted on the limbs of the U-shaped core are connected in series and have an opposite winding direction. The yoke is interrupted between the individual U-shaped iron cores of the different phases U, V, W. As a consequence, the magnetic flux of the phase U is prevented from passing via the yoke into the magnetic circuit that is allocated to the tooth coils of the phase V. The magnetic interaction that is realized in accordance with the current embodiments of the prior art between the different phases is prevented in this manner.

Measurements and simulations have demonstrated that the interruption of the yoke between the groups having an identical electrical phase has a particular strong influence on the force ripples. In comparison to linear motors in which the yoke magnetically connects the teeth of all tooth coils to one another and consequently generates a magnetic neutral point, the force ripples are considerably reduced.

FIG. 2 illustrates one embodiment of the disclosure as a circuit board motor. The circuit board motor is configured as a linear motor. A cross sectional view of only a portion of the primary part 1 of the motor is illustrated. This illustrates a solenoid coil that is integrated in a multi-layer printed circuit board. The multi-layer printed circuit board is configured from three individual printed circuit boards that are layered one above the other. Each of these three printed circuit boards has a spiral-shaped flat coil 11-16 both on the upper face of the printed circuit board and also on the lower face of the individual printed circuit board. The uppermost individual printed circuit board of the stack thus supports on its upper face a first flat coil 11, three windings of which are apparent in the cross sectional view, said windings being arranged in a lateral direction adjacent to one another. A second flat coil 12 is located on the lower face of said individual printed circuit board that forms the uppermost plane of the stack, the winding direction of said second flat coil corresponding to that of the first flat coil 11.

A second individual printed circuit board is located below this first plane that is formed by the first individual printed circuit board having the first flat coil 11 and the second flat coil 12, a third flat coil 13 is arranged on the upper face of said second individual printed circuit board and a fourth flat coil 14 is arranged on the lower face of said second individual printed circuit board. The winding direction of these flat coils 13, 14 also corresponds to that of the flat coils 11, 12 of the first individual printed circuit board. Finally, a further individual printed circuit board is located on the lowermost plane of the multi-layer printed circuit board, a fifth flat coil 15 is arranged on the upper face of said further individual printed circuit board and a sixth flat coil 16 is arranged on the lower face of said individual printed circuit board. The form of the windings of the fifth flat coil 15 and sixth flat coil 16 corresponds to that of the flat coils 11, 12, 13, 14 that are arranged above said fifth and sixth flat coil.

During the manufacturing process, the individual printed circuit boards are initially manufactured with their allocated flat coils 11-16. Subsequently, insulating pre-preg layers (not illustrated here) are arranged between the different individual printed circuit boards and said pre-preg layers respectively electrically insulate lower flat coils of an individual printed circuit board 12, 14 from the underlying upper flat coil 13, 15 of the respectively underlying individual printed circuit board.

The conductor tracks of the different flat coils are generally configured from copper and are located on a PCB substrate, such as by way of example FR4 that forms the respective individual layer or individual printed circuit board. Once the different substrates that are respectively separated by one or two sheets of the pre-preg material have been stacked one above the other, the entire stack that has been formed in this manner is laminated in order to produce a mechanical connection between the substrates.

In order to form a solenoid coil from the different flat coils 11-16, it is still necessary for the flat coils 11-16 to make electrical contact with one another. This generally occurs by an electrical through-connection, so-called VIAs, which are not illustrated in FIG. 1.

An iron core passes through the solenoid coil in an axial manner, said iron core considerably increases the inductance of the solenoid coil and the force density, which may be realized with the linear motor, in comparison to the air coil. A limb 7 of the U-shaped iron core that has already been previously described in connection with FIG. 1 is illustrated. It is also possible to recognize in sections a yoke part 6 that connects the limb 7 in a magnetically conductive manner to a further limb 7, wherein said further limb passes through a further solenoid coil that is realized on the multi-layer printed circuit board, the winding direction of said solenoid coil being opposite to the winding direction illustrated in FIG. 2 and the phase current flowing through said solenoid coil being the same. The thus described arrangement comprising a U-shaped iron core repeats in the lateral direction according to the number of phases and pole number of the primary part and two laterally offset solenoid coils having an identical phase pass through said iron core.

The circuit track sections of the different windings of each flat coil 11-16 need to be spaced sufficiently far away from one another in the lateral direction in order to ensure the electrical insulation between the individual windings. However, this electrical insulation spacing may also be overcome during the dissipation of heat that occurs in the inner windings of each flat coil 11-16 and may be discharged at the edge of the multi-layer printed circuit board in the direction of the surface. Particularly in the case when the cross section of each conductor track is to be selected sufficiently large in order to be able to carry a highest possible current, a spacing of the conductor tracks in the lateral direction is in the magnitude of some hundred micrometers alone for manufacturing related reasons. Consequently, it is apparent that this electrical insulating spacing represents an obstacle for the heat dissipation of the multi-layer printed circuit board.

FIG. 3 illustrates a further embodiment of the disclosure as a circuit board motor with improved heat dissipation, wherein a cross section of a lateral section of a multi-layer printed circuit board is apparent. The multi-layer printed circuit board here also forms a solenoid coil that is formed by electrically connecting a total of six flat coils 11-16 that are arranged in planes that lie one above the other in the vertical direction. In this case, a first individual layer here also supports on its upper face a first flat coil 11 and on its lower face the second flat coil 12. The two flat coils 11, 12 have been applied prior to forming the multi-layer stack on the PCB substrate. The same applies for the third flat coil 13 and the fourth flat coil 14 that likewise have been applied to the PCB substrate prior to producing the entire stack. The fifth flat coil 15 has likewise been applied to the upper face of the third individual printed circuit board and the sixth flat coil 16 to the lower face of this individual printed circuit board.

However, in contrast to the prior art illustrated in FIG. 2, in this case respectively two flat coils 11-16 that are directly adjacent to one another in the vertical direction are arranged offset with respect to one another in the lateral direction. It is ensured in this manner that by way of example each conductor track section 9 of the second flat coil 12 is arranged in part overlapping with two conductor track sections 10 of the first flat coil 11. Likewise, by way of example the conductor track section of the third flat coil 13, which represents the middle winding, is arranged in part overlapped by two conductor track sections of the second flat coil 12 that lie one above the other when viewed in the vertical direction.

The arrows in the figure visualize how, by virtue of the lateral offset arrangement of the flat coils that are directly adjacent to one another in the vertical direction, the heat transfer from the inner windings of each flat coil 11-16 to the outer edge region of each flat coil 11-16 is improved. By way of example, said heat transfer of the second and third flat coil 12, 13 is illustrated in FIG. 3. By virtue of the overlapping region in sections between two conductor track sections that are adjacent to one another in the vertical direction, it is only necessary for a considerably smaller spacing to be bridged by electrically insulating and consequently also thermally insulating material such as FR-4 that is frequently used for circuit boards.

It is also apparent in FIG. 3 that the spacing between the second flat coil 12 and the third flat coil 13 is smaller in the vertical direction than the spacing between the first flat coil 11 and the second flat coil 12. Likewise, the spacing between the fourth flat coil 14 and the fifth coil 15 is considerably smaller than the spacing between the fifth flat coil 15 and the sixth flat coil 16. This is ascribed to the underlying connection technology between the previously already mentioned individual layers. If in order to connect the individual printed circuit boards only a very thin pre-preg material is used or alternatively a mere baking lacquer layer is used, the insulating connecting layer between the individual printed circuit boards that are to be connected to form a stack may be selected to be thinner than the thickness of the substrate on which the flat coils of each individual printed circuit board are arranged. It is possible in this manner, insofar as the required electrically insulating spacing allows, to still further improve the heat dissipation from the central inner region of the solenoid coil to the outer region of the solenoid coil.

### LIST OF REFERENCE NUMERALS

1 Primary part

2 Secondary part

3 Air gap

4 Permanent magnet

5 Soft iron plate

6 Yoke part

7 Limb

8 Tooth coil

9, 10 Conductor track sections

11-16 Flat coils

1. A dynamo-electric machine comprising
a primary part having a plurality of teeth, grooves that are located between the teeth and a yoke that is produced from a ferromagnetic material,
a secondary part that is spaced apart from the primary part via an air gap and comprises a plurality of permanent magnets that lie adjacent to one another with alternating polarity,
a multi-phase tooth coil winding that is arranged in the grooves, wherein adjacent tooth coils are connected to form groups having an identical electrical phase,
wherein adjacent teeth of groups of tooth coils having an identical electrical phase are connected in a magnetically conductive manner via the yoke and
the yoke is interrupted between adjacent tooth coils having a different electrical phase.

2. The dynamo-electric machine as claimed in claim 1, wherein the adjacent tooth coils having an identical electrical phase are connected in series and comprise an opposite winding direction.

3. The dynamo-electric machine as claimed in claim 2, wherein one group respectively comprises precisely two tooth coils that are arranged in series, are wound in opposite directions and the same phase current flows through the tooth coils.

4. The dynamo-electric machine as claimed in claim 3, wherein the yoke comprises multiple yoke parts that respectively connect to one another in a magnetically conductive manner via two teeth having two tooth coils that are connected in series.

5. The dynamo-electric machine of claim 1 wherein the primary part is configured as a circuit board that supports the tooth coils, the teeth and the yoke, wherein the interruptions of the yoke between the groups having a different electrical phase are filled by a composite material of the circuit board.

6. The dynamo-electric machine as claimed in claim 5, wherein the circuit board is configured as a multi-layer printed circuit board and the tooth coils are configured as solenoid coils that respectively comprise multiple flat coils that lie one above the other in a vertical direction.

7. The dynamo-electric machine as claimed in claim 6, wherein respectively two flat coils that are adjacent to one another in the vertical direction are arranged laterally offset with respect to one another in such a manner that in a cross section perpendicular to a surface of the multi-layer printed circuit board the conductor track sections of one flat coil are arranged in part overlapping in the vertical direction with two conductor track sections of the other flat coil.

8. The dynamo-electric machine as claimed in claim 7, wherein the outer conductor track sections of adjacent tooth coils engage with one another in a comb-shaped manner such that the cross section respectively one outer conductor track section of one tooth coil is arranged in part overlapping in a vertical direction with at least one outer conductor track section of the adjacent tooth coil.

9. The dynamo-electric machine of claim 1, wherein the dynamo-electric machine is configured as a linear motor.

10. A dynamo-electric machine comprising:
a circuit board configured to support a yoke, teeth connected to the yoke, and grooves located between the teeth and the yoke;
a secondary part that is spaced apart from the circuit board via an air gap, wherein the secondary part includes a plurality of permanent magnets that lie adjacent to one another with alternating polarity; and
a multi-phase tooth coil winding that is arranged in the grooves, wherein adjacent tooth coils are connected to form groups having an identical electrical phase and adjacent teeth of the groups of tooth coils having an identical electrical phase are connected in a magnetically conductive manner via the yoke, wherein the yoke is interrupted between adjacent tooth coils having a different electrical phase.

11. The dynamo-electric machine of claim 10, wherein the adjacent tooth coils having an identical electrical phase are connected in series and comprise an opposite winding direction.

12. The dynamo-electric machine of claim 11, wherein one group respectively comprises two tooth coils that are arranged in series and that are wound in opposite directions and the same phase current flows through the tooth coils.

13. The dynamo-electric machine of claim 12, wherein the yoke includes multiple yoke parts that respectively connect to one another in a magnetically conductive manner via two teeth having two tooth coils.

14. The dynamo-electric machine of claim 10, wherein interruptions of the yoke between the groups having a different electrical phase are filled by a composite material of the circuit board.

15. The dynamo-electric machine of claim 14, wherein the circuit board is configured as a multi-layer printed circuit board and the tooth coils are configured as solenoid coils that include multiple flat coils that lie one above the other in a vertical direction.

16. The dynamo-electric machine of claim 15, wherein respectively two flat coils that are adjacent to one another in the vertical direction are arranged laterally offset with respect to one another in such a manner that in a cross section perpendicular to the surface of the multi-layer printed circuit board, conductor track sections of one flat coil are arranged in part overlapping in the vertical direction with two conductor track sections of another flat coil.

17. The dynamo-electric machine as claimed in claim 16, wherein the outer conductor track sections of adjacent tooth coils engage with one another in a comb-shaped manner with the result that in the cross section respectively one outer conductor track section of one tooth coil is arranged in part overlapping in the vertical direction with at least one outer conductor track section of the adjacent tooth coil.

18. The dynamo-electric machine of claim 1, wherein the dynamo-electric machine is configured as a rotary electrical machine.

19. A dynamo-electric machine comprising:
a sheet metal having a plurality of teeth, a yoke, and grooves located between the teeth and the yoke;
a plurality of permanent magnets that lie adjacent to one another with alternating polarity on an iron plate, wherein the plurality of permanent magnets are spaced apart from the sheet metal via an air gap; and
a multi-phase tooth coil winding that is arranged in the grooves, wherein adjacent tooth coils are connected to form groups having an identical electrical phase, wherein adjacent teeth of the groups of tooth coils having an identical electrical phase are connected in a magnetically conductive manner via the yoke.

20. The dynamo-electric machine of claim 19, wherein the yoke is interrupted between adjacent tooth coils having a different electrical phase.
